(19) United States
(12) Patent Application Publication
(10) Pub. No.: US 2011/0048321 A1
(43) Pub. Date: Mar. 3, 2011

(54) COATING APPARATUS

(75) Inventor: SHAO-KAI PEI, Tu-Cheng (TW)

(73) Assignee: HON HAI PRECISION INDUSTRY CO., LTD., Tu-Cheng (TW)

(21) Appl. No.: 12/763,185

(22) Filed: Apr. 19, 2010

(30) Foreign Application Priority Data
Aug. 25, 2009 (CN) 200910306029.1

(51) Int. Cl. B05B 7/06

(52) U.S. Cl. 118/314

(57) ABSTRACT

A coating apparatus includes a first coating element, a second coating element, an isolating element, at least one isolating block, and at least one linear driving element. The isolating element includes a main chamber and at least one secondary chamber communicating with the main chamber. The first coating element is connected to one end of the isolating element, and the second coating element is connected to an opposite end of the isolating element. Each of the at least one isolating block is received in one of the at least one secondary chamber. Each of the at least one linear driving element is mounted in one of the at least one secondary chamber and connected to one of the at least one isolating block.

### BACKGROUND

1. Technical Field

The present disclosure relates to coating apparatuses and, particularly, to a coating apparatus for multi-layer coating.

2. Description of Related Art

It is common to use more than one kind of coating process, such as, spraying, ion sputtering, vapor deposition, or spray pyrolysis when applying multiple coats of materials such as paint or primer to a workpiece. Generally, each coating process must be carried out within a different vacuum chamber of a machine capable of carrying out the desired coating process. To complete these coating processes, the workpiece must be transported from one vacuum chamber to another. However, during the transportation, the workpiece may be exposed to the environment and may be contaminated.

### BRIEF DESCRIPTION OF THE DRAWINGS

The components of the drawings are not necessarily drawn to scale, the emphasis instead being placed upon clearly illustrating the principles of a coating apparatus. Moreover, in the drawings, like reference numerals designate corresponding parts throughout several views.

FIG. 1 is an isometric view of a coating apparatus in accordance with an exemplary embodiment.

FIG. 2 is an exploded, perspective view of the coating apparatus of FIG. 1.

FIG. 3 is another exploded, perspective view of the coating apparatus of FIG. 1, but showing another aspect.

FIG. 4 is a cross-sectional view of the coating apparatus of FIG. 1, showing the coating apparatus in a first state.

FIG. 5 is similar to FIG. 4, but showing the coating apparatus in a second state.

FIG. 6 is similar to FIG. 4, but showing the coating apparatus in a third state.

### DETAILED DESCRIPTION

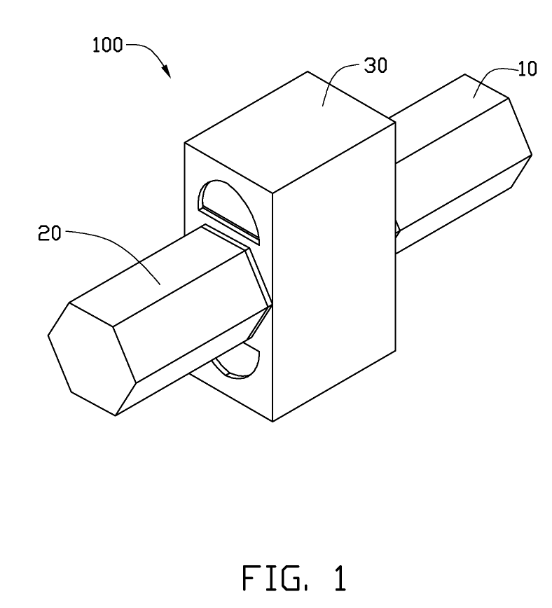

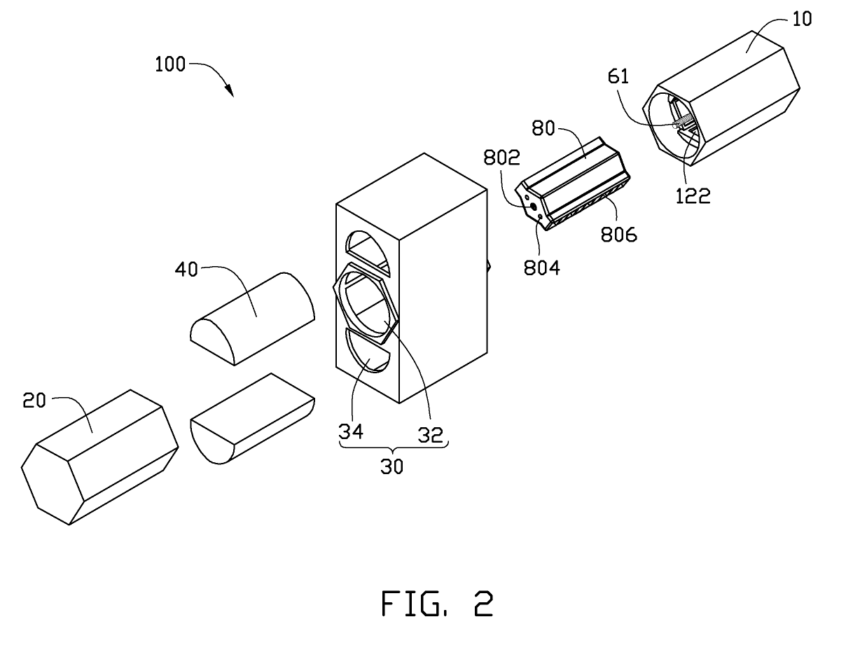

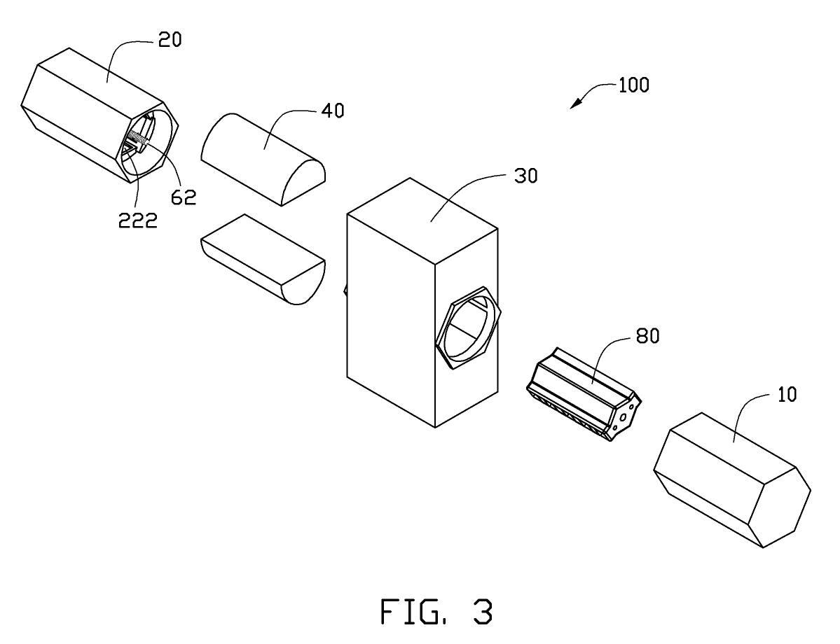

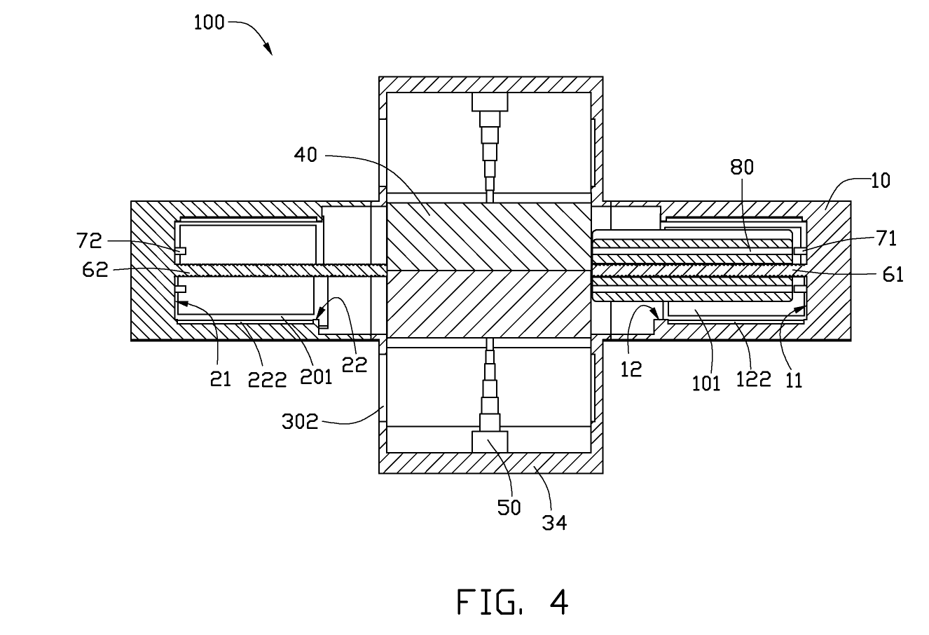

Referring to FIGS. 1-4, an embodiment of a coating apparatus 100 is illustrated. The coating apparatus 100 includes a first coating element 10, a second coating element 20, an isolating element 30, a pair of isolating blocks 40, and a pair of linear driving elements 50. The isolating element 30 includes a main chamber 32 and a pair of secondary chambers 34. The main chamber 32 is arranged between the secondary chambers 34 and communicates with the secondary chambers 34. The first coating element 10 is connected to one end of the isolating element 30 via the main chamber 32, and the second chamber 20 is connected to an opposite end of the isolating element 30 via the main chamber 32. Each of the secondary chambers 34 is shaped to fit one isolating block 40. Each of the linear driving elements 50 is mounted in one secondary chamber 34 and connected to one isolating block 40. The linear driving elements 50 are configured to drive the isolating blocks 40 to move into the main chamber 32 to isolate the first coating element 10 from the rest of the apparatus 100 during the times when the first coating element 10 is applied in a coating process, and to isolate the second coating element 20 from the rest of the apparatus 100 during the times when the second coating element 20 is applied in a coating process, and further, to drive the isolating blocks 40 to move out of the main chamber 32 after a coating process is finished.

The first coating element 10 includes a first bottom surface 11 and a first inner sidewall 12. The first bottom surface 11 and the first inner sidewall 12 cooperatively form a first receiving space 101 to receive a substrate holder 80. A plurality of first slots 122 is formed in the first inner sidewall 12 to receive coating material.

A first threaded pole 61 is mounted on the first bottom surface 11. The first threaded pole 61 extends along an axis of the first coating element 10 and is retained within the coating element 10. The first thread pole 61 can rotate with respect to the first coating element 10.

A pair of first telescoping poles 71 is mounted on the first bottom surface 11. The first treaded pole 61 is arranged between the first telescoping poles 71. Each of the first telescoping poles 71 can telescope out and withdraw along the axis of the first coating element 10.

The structure of the second coating element 20 is the same as that of the first coating element 10. The second coating element 20 includes a second bottom surface 21, a second inner sidewall 22, a second receiving space 201, a plurality of second slots 222, a second threaded pole 62, and a pair of second telescoping poles 72.

The substrate holder 80 can be driven to move from the first coating element 10 into the second coating element 20 or from the second coating element 20 to the first coating element 10 via the isolating element 30. The substrate holder 80 defines a threaded hole 802 and a pair of fixing holes 804. The threaded hole 802 is shaped to fit the first threaded pole 61 and the second threaded pole 62. The fixing holes 804 are shaped to fit the first telescoping poles 71 and the second telescoping poles 72. The substrate holder 80 defines a plurality of recessed portions 806 along the lateral surface of the substrate holder 80. Each of the recessed portions 806 is configured to receive a substrate (not shown).

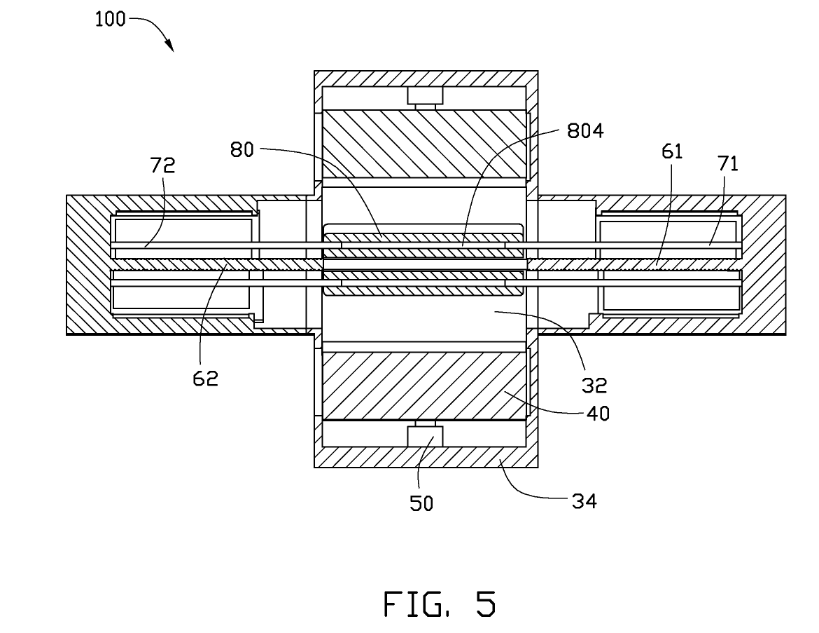

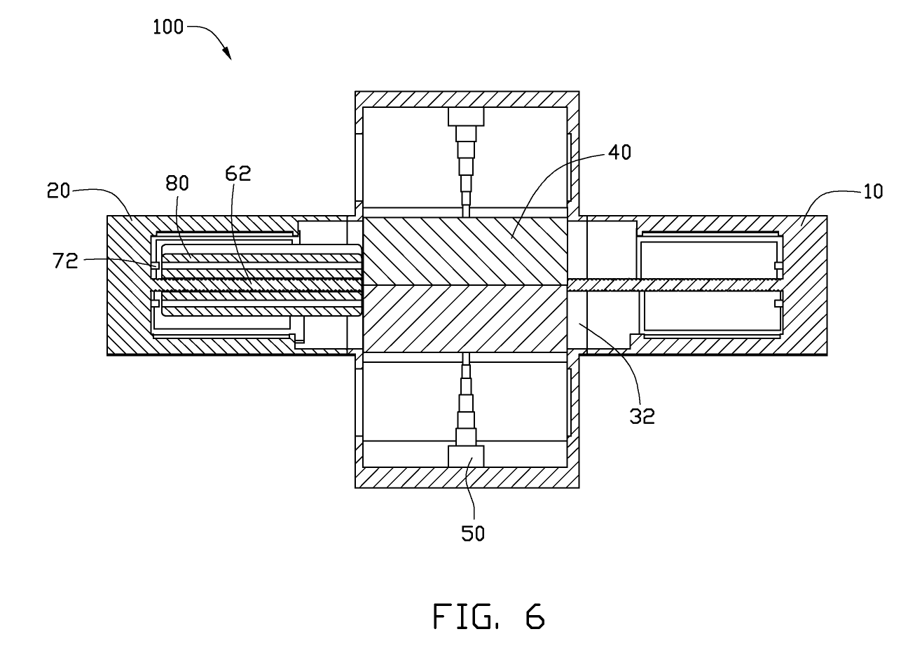

Referring also to FIGS. 5-6, in operation, a plurality of substrates (not shown) are put in the recessed portions 806, respectively. The substrate holder 80 is connected to the first coating element 10 via the engagement of the first threaded pole 61 in the threaded hole 802. The first coating element 10 is connected to the end of the isolating element 30. The linear driving elements 50 drive the isolating blocks 40 to move into the main chamber 32 to isolate the first coating element 10 from the rest of the coating apparatus 100. The first threaded pole 61 rotates to drive the substrate holder 80 to rotate inside the first coating element 10. Consequently, a first coating process is carried out in the first coating element 10. The substrates are thus coated with a first layer (not shown).

After the first coating process is finished, the linear driving elements 50 drive the isolating blocks 40 to move out of the main chamber 32. The first telescoping poles 71 telescope out to extend through the fixing holes 804, thus the rotation of the substrate holder 80 about the first threaded pole 61 is limited, and the substrate holder 80 moves to the main chamber 32 due to the rotation of the first threaded pole 61. Once the substrate holder 80 is fully received in the main chamber 32, the first threaded pole 61 is out of the threaded hole 802, and the first telescoping poles 71 withdraw from the fixing holes 804, and the second telescoping poles 72 telescope out to extend through the fixing holes 804, and the second threaded pole 62 engages the threaded hole 802. Thereby, the substrate holder 80 moves to the second coating element 20 due to the rotation of the second threaded pole 62. Once the substrate holder 80 is fully received in the second coating element 20, the second telescoping poles 72 withdraw from the fixing holes 804, thus the substrate holder 80 can rotate about the second threaded pole 62. Also, once the substrate holder 80 is fully received in the second coating element 20, the linear driving elements 50 drive the isolating blocks 40 to move into the main chamber 32 to isolate the second coating element 20 from the rest of the apparatus 100. Consequently, a second coating process is carried out in the second coating element 20. The substrates are thus coated with a second layer.

It should be noted that the coating apparatus 100 is not limited to the configuration of this embodiment. For example, two isolating elements and three coating elements are employed. One isolating element is disposed between two coating elements, thus the substrates can be coated with three layers. Also, only one secondary chamber and only one isolating block is employed. The shape of the secondary chamber and the isolating block is the same as that of the main chamber.

With such configuration, when using the coating apparatus 100, the substrates can be coated with multi-layers without exposing to the environment. Furthermore, when a coating process is carried out in one coating element, the coating element is isolated form the rest of the coating apparatus 100. Therefore, the substrates cannot be easily contaminated.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A coating apparatus, comprising:
a first coating element;
a second coating element;
an isolating element comprising a main chamber and at least one secondary chamber communicating with the main chamber, wherein the first coating element is connected to one end of the isolating element via the main chamber, and the second coating element is connected to an opposite end of the isolating element via the main chamber;
at least one isolating block, wherein each of the at least one isolating block is received in one of the at least one secondary chamber; and
at least one linear driving element, wherein each of the at least one linear driving element is mounted in one of the at least one secondary chamber and connected to one of the at least one isolating block, the driving element is able to drive the at least one isolating block to move into the main chamber and further to drive the isolating blocks to move out of the main chamber.

2. The coating apparatus as described in claim 1 further comprising a substrate holder, wherein the first coating element defines a first receiving space, the second coating element defines a second receiving space, the main chamber communicates with the first receiving space and the second receiving space, the substrate holder is able to move inside the first receiving space, the second receiving space, and the main chamber.

3. The coating apparatus as described in claim 2 further comprising a first threaded pole and a second threaded pole, wherein the first threaded pole is mounted in the first receiving space and extends along an axis of the first coating element, the second threaded pole is mounted in the second receiving space and extends along an axis of the second coating element, the substrate holder defines a threaded hole, the substrate holder is connected to the first coating element via the engagement of the first threaded pole in the threaded hole, and the substrate holder is connected to the second coating element via the engagement of the second threaded pole in the threaded hole.

4. The coating apparatus as described in claim 3 further comprising at least one first telescoping pole and at least one second telescoping pole, wherein the at least one first telescoping pole is mounted in the first receiving space and is able to telescope out and withdraw along the axis of the first coating element, the at least one second telescoping pole is mounted in the second receiving space and is able to telescope out and withdraw along the axis of the second coating element, the substrate holder defines at least one fixing hole, each of the at least one first telescoping pole is able to telescope out to extend through one of the at least one fixing hole, and each of the at least one second telescoping pole is able to telescope out to extend through one of the at least one fixing hole.

5. The coating apparatus as described in claim 2, wherein the first receiving space defines at least one first slot, the second receiving space defines at least one second slot, the at least one first slot and the at least one second slot are configured to receive coating material.

6. The coating apparatus as described in claim 1, wherein the at least one secondary chamber comprises one secondary chamber, the at least one isolating block comprises at least one isolating block, the shape of the at least one secondary chamber is the same as that of the main chamber and the at least one isolating block.

7. The coating apparatus as described in claim 1, wherein the at least one secondary chamber comprises a pair of secondary chambers, the at least one isolating block comprises a pair of isolating blocks, the main chamber is arranged between the secondary chambers.
